(19) United States
(12) Patent Application Publication
(10) Pub. No.: US 2016/0319729 A1
(43) Pub. Date: Nov. 3, 2016

(54) COMBUSTION CHAMBER STRUCTURE OF SPARK-IGNITION INTERNAL COMBUSTION ENGINE

(71) Applicant: TOYOTA JIDOSHA KABUSHIKI KAISHA, Toyota-shi (JP)

(72) Inventor: Hiroyuki SAKAI, Gotemba-shi (JP)

(73) Assignee: TOYOTA JIDOSHA KABUSHIKI KAISHA, Toyota-shi (JP)

(21) Appl. No.: 15/107,999

(22) PCT Filed: Dec. 15, 2014
(86) PCT No.: PCT/IB2014/002766

§ 371 Date: Jun. 24, 2016

(30) Foreign Application Priority Data
Dec. 26, 2013 (JP) 2013-268703

(51) Int. Cl. F02B 23/10

(52) U.S. Cl. CPC F02B 23/10; F02B 2023/106

(57) ABSTRACT

A combustion chamber structure includes a squish area located in a first region surrounded by an opening of an intake port and a wall of a cylinder bore in an outer peripheral portion of the combustion chamber. The first region has a first height, and the first height is smaller than the height of any region of the outer peripheral portion of the combustion chamber other than the first region. The combustion chamber structure further includes a reverse squish area located in a second region surrounded by an opening of an exhaust port and the wall of the cylinder bore in the outer peripheral portion of the combustion chamber. The second region has a second height, and the second height is larger than the height of any region of the outer peripheral portion of the combustion chamber other than the second region.

### BACKGROUND OF THE INVENTION

1. Field of the Invention

The invention relates to a combustion chamber structure of a spark-ignition internal combustion engine.

2. Description of Related Art

In a spark-ignition internal combustion engine as described in Japanese Patent Application Publication No. 2009-41397 (JP 2009-41397 A), airflows drawn from two intake ports form tumble flow directed toward two exhaust ports while swirling in an axial direction of a cylinder, such that twin airflows (twin vortexes) that rotate in mutually opposite directions are produced from the tumble flow. If the twin airflows are produced, flame propagation after ignition is deflected to one side in an intake-exhaust direction of a combustion chamber. In this respect, in the combustion chamber structure of JP 2009-41397 A, two squish areas provided on the intake side and the exhaust side are formed with different widths, so that the width of the squish area on the side to which the flame propagation is deflected is made larger than that of the squish area on the other side. Accordingly, knocking that would be caused by deflection of flame propagation can be prevented in advance.

### SUMMARY OF THE INVENTION

In the combustion chamber structure of JP 2009-41397 A, the cross-sectional shape of the combustion chamber in the vicinity of the top dead center of the piston is designed so as to match the shape of flame propagated when the twin airflows are produced. Thus, this combustion chamber structure cannot curb or prevent production of the twin airflows itself.

The invention provides a combustion chamber structure that curbs or prevents production of twin airflows that rotate in mutually opposite directions, from tumble flow formed in a combustion chamber.

A combustion chamber structure for an internal combustion engine, which is configured to produce tumble flow as airflow directed from an intake side to an exhaust side, in the vicinity of an upper wall of a combustion chamber, is provided according to one aspect of the invention. The combustion chamber structure includes a squish area located in a first region surrounded by an opening of an intake port and a wall of a cylinder bore in an outer peripheral portion of the combustion chamber. The first region of the combustion chamber has a first height as measured in an axial direction of a cylinder when a piston of the internal combustion engine is located at a top dead center, and the first height is smaller than a height of any region of the outer peripheral portion of the combustion chamber other than the first region. The combustion chamber structure further includes a reverse squish area located in a second region surrounded by an opening of an exhaust port and the wall of the cylinder bore in the outer peripheral portion of the combustion chamber. The second region of the combustion chamber has a second height as measured in the axial direction of the cylinder when the piston is located at the top dead center, and the second height is larger than a height of any region of the outer peripheral portion of the combustion chamber other than the second region.

The twin airflows produced from the tumble flow have an airflow component directed from the exhaust side to the intake side of the combustion chamber. With the above arrangement, airflow whose direction is opposite to the direction of the airflow component is produced from the squish area, at around the compression top dead center, so that the airflow is drawn into the reverse squish area, to be intensified. As a result, the above-mentioned airflow component can be cancelled out, so that production of the twin airflows itself can be curbed or prevented.

The combustion chamber structure as described above may further include a middle area and a sub squish area. The middle area is located in a third region surrounded by the opening of the intake port, the opening of the exhaust port, and the wall of the cylinder bore, in the outer peripheral portion of the combustion chamber. The third region has a third height as measured in the axial direction of the cylinder when the piston is located at the top dead center, and the third height is between the first height of the first region and the second height of the second region. The sub squish area is located between the middle area and the reverse squish area, and the sub squish area has a height substantially equal to the first height of the first region when the piston is located at the top dead center.

The twin airflows produced from the tumble flow have an airflow component directed from the intake side to the exhaust side in the intake-exhaust direction in the outer peripheral portion of the combustion chamber. With the above arrangement, airflow whose direction is opposite to the direction of the airflow component in the outer peripheral portion can be produced from the sub squish area, at around the compression top dead center. As a result, the airflow component of the outer peripheral portion can be cancelled out, and production of the twin airflows can be favorably curbed or prevented.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic cross-sectional view of a combustion chamber of an internal combustion engine according to one embodiment of the invention;

FIG. 2 is a plan view of a combustion chamber as viewed from a cylinder head side;

FIG. 3A is a IIIA-IIIA cross-sectional view of FIG. 2;

FIG. 3B is a IIIB-IIIB cross-sectional view of FIG. 2;

FIG. 3C is a IIIC-IIIC cross-sectional view of FIG. 2;

FIG. 4 is a view useful for explaining the operation based on the structure of the combustion chamber;

FIG. 5 is a view showing changes in the gas flow rate at around the compression top dead center;

FIG. 6A and FIG. 6B are views showing airflow distribution at the compression top dead center in a combustion chamber for comparison;

FIG. 7 is a view showing velocity distribution of airflow at the compression top dead center in the combustion chamber for comparison;

FIG. 8 is a view showing flame propagation in the combustion chamber for comparison with a lapse of time;

FIG. 9 is a view useful for explaining effects based on the structure of the combustion chamber according to the embodiment of the invention; and

FIG. 10 is a view showing a modified example of the embodiment of the invention.

### DETAILED DESCRIPTION OF EMBODIMENTS

A combustion chamber structure of an internal combustion engine according to one embodiment of the invention will be described with reference to the drawings.

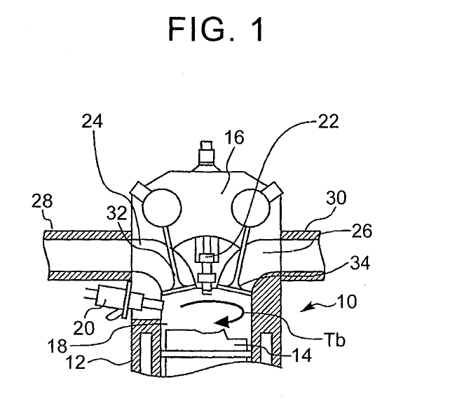

The internal combustion engine of this embodiment is installed as a driving source on a mobile body, such as a vehicle. FIG. 1 is a schematic cross-sectional view of a combustion chamber of the engine according to the embodiment of the invention. As shown in FIG. 1, a piston 14 is provided in a cylinder 12 of the engine 10 such that the piston 14 can reciprocate in the cylinder 12 in sliding contact therewith. A cylinder head 16 is mounted on the cylinder 12. A combustion chamber 18 is defined by a bore wall of the cylinder 12, a top face of the piston 14, and a bottom of the cylinder head 16.

A fuel injection valve 20 for directly injecting fuel into the combustion chamber 18 is provided in the cylinder head 16. An ignition plug 22 for igniting an air/fuel mixture in the combustion chamber 18 is also provided in the cylinder head 16. Namely, the internal combustion engine 10 is an in-cylinder or direct injection type spark-ignition engine. The engine 10 may be a port injection type spark-ignition engine.

Intake ports 24 and exhaust ports 26 are formed in a lower surface of the cylinder head 16. The combustion chamber 18 communicates with an intake passage 28 via the intake ports 24, and communicates with an exhaust passage 30 via the exhaust ports 26. The intake ports 24 are formed in such a shape as to promote production of tumble flow of intake air as vertical flow that swirls in a direction indicated by arrow Tb in FIG. 1. An airflow control valve for effectively producing the tumble flow may be provided in the intake passage 28. An intake valve 32 is provided in each of the intake ports 24. An exhaust valve 34 is provided in each of the exhaust ports 26.

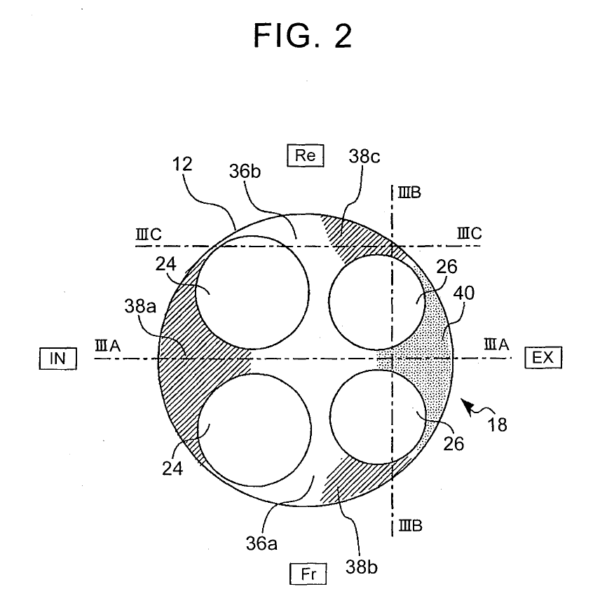

FIG. 2 is a plan view of the combustion chamber 18 as viewed from the cylinder head 16 side. In FIG. 2, “IN” denotes the intake side of the combustion chamber 18, and “EX” denotes the exhaust side of the combustion chamber 18. “Fr” denotes the front of the mobile body on which the internal combustion engine 10 is installed, and “Re” denotes the rear of the mobile body.

As shown in FIG. 2, an outer peripheral portion of the combustion chamber 18 consists of three types of regions 36, 38, 40. The region 36 is formed at two locations (36a, 36b) in the outer peripheral portion of the combustion chamber 18. More specifically, the region 36a is formed outside an opening of the intake port 24 on the Fr (front) side of the combustion chamber 18, and inside the bore wall of the cylinder 12. The region 36b is formed outside an opening of the intake port 24 on the Re (rear) side of the combustion chamber 18, and inside the bore wall of the cylinder 12. The region 38 is formed at three locations (regions 38a-38c) in the outer peripheral portion of the combustion chamber 18. More specifically, the region 38a is formed outside the openings of the two intake ports 24 on the IN (intake) side of the combustion chamber 18, and inside the bore wall of the cylinder 12. The region 38b is formed outside an opening of the exhaust port 26 on the Fr (front) side of the combustion chamber 18, and inside the bore wall of the cylinder 12. The region 38c is formed outside an opening of the exhaust port 26 on the Re (rear) side of the combustion chamber 18, and inside the bore wall of the cylinder 12. The regions 38a-38c form squish areas between the top face of the piston 14 and the bottom of the cylinder head 16 opposed to the top face, when the piston 14 is located at the top dead center. The region 40 is formed in an outer peripheral portion of the Ex (exhaust) side of the combustion chamber 18. More specifically, the region 40 is formed outside the openings of the two exhaust ports 26 on the Ex (exhaust) side of the combustion chamber 18, and inside the bore wall of the cylinder 12.

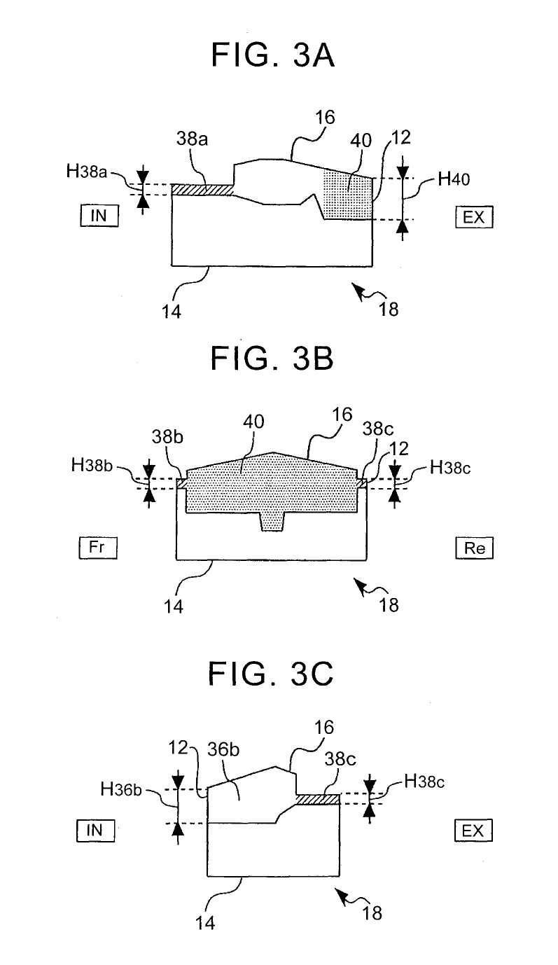

FIG. 3A-FIG. 3C are cross-sectional views of FIG. 2. FIG. 3A is a IIA-IIA cross-sectional view of FIG. 2, and FIG. 3B is a IIB-IIB cross-sectional view of FIG. 2, while FIG. 3C is a IIC-IIC cross-sectional view of FIG. 2. In FIG. 3A-FIG. 3C, H_{36b} is the height of the region 36b measured along the bore wall of the cylinder 12. H₃₈ₐ is the height of the region 38a measured along the bore wall of the cylinder 12, and H_{38b} is the height of the region 38b measured along the bore wall of the cylinder 12, while H_{38c} is the height of the region 38c measured along the bore wall of the cylinder 12. H₄₀ is the height of the region 40 measured along the bore wall of the cylinder 12.

The heights H₃₈ₐ, H_{38b}, and H_{38c} as shown in FIG. 3 have a relationship that H₃₈ₐ=H_{38b}=H_{38c}. This is because the region 38a, region 38b and the region 38c form squish areas. The height H_{36b} and the height H₄₀ have a relationship that H_{36b}<H₄₀.

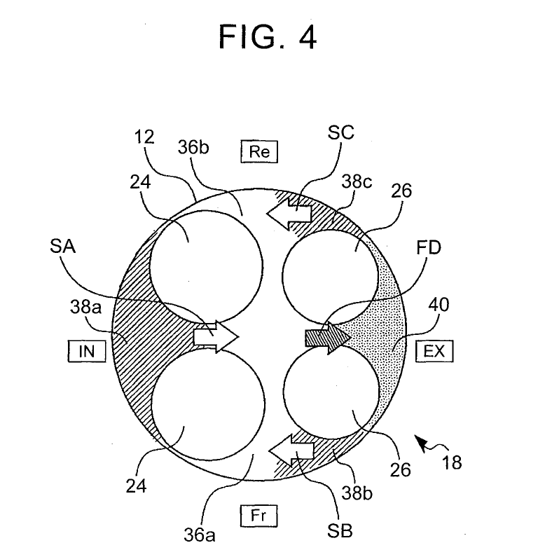

FIG. 4 is a view useful for explaining the operation based on the structure of the combustion chamber 18. With the regions 38a-38c thus formed, squish flows are produced in the vicinity of the compression top dead center. More specifically, squish flow SA directed from the region 38a side toward a central portion of the combustion chamber 18 is produced on the IN (intake) side of the combustion chamber 18. Similarly, squish flow SB directed from the region 38b side toward the region 36a side is produced, in a Fr-side outer peripheral portion of the combustion chamber 18, and squish flow SC directed from the region 38c side toward the region 36b side is produced, in a Re-side outer peripheral portion of the combustion chamber 18. Also, with the region 40 thus formed, airflow FD directed from the central portion of the combustion chamber 18 toward the region 40 side is produced in the vicinity of the compression top dead center. If the airflow FD is produced, the squish flow SA produced in the central portion of the combustion chamber 18 moves such that it is drawn into the region 40.

The regions 38a-38c are different from the region 40 in that the regions 38a-38c give rise to airflows (i.e., squish flows SA-SC) directed from the outer periphery of the combustion chamber 18 toward the center thereof, whereas the region 40 gives rise to airflow (i.e., airflow FD) directed from the center of the combustion chamber 18 toward the outer periphery thereof. Thus, in this specification, the region 40 is also called “reverse squish area”.

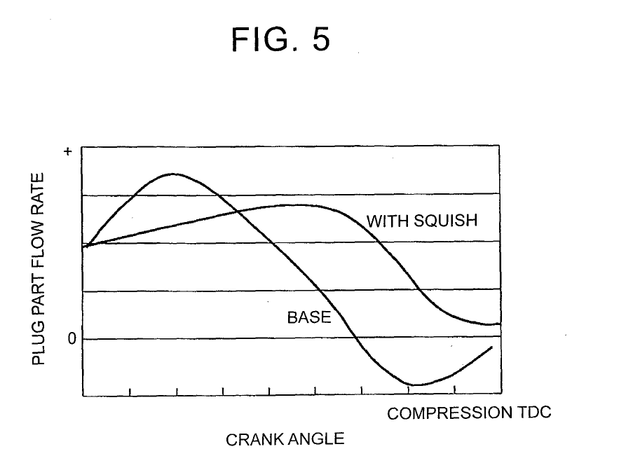

Referring to FIG. 5 through FIG. 9, effects based on the structure of the combustion chamber 18 will be described. FIG. 5 shows changes in the gas flow rate at around the compression top dead center. The graph of FIG. 5 is plotted by measuring the gas flow rate (plug part flow rate) in the combustion chamber, using a measuring instrument inserted in a plug hole. In FIG. 5, the vertical axis indicates measurement value of the gas flow rate. More specifically, the measurement value of the gas flow rate assumes a positive (+) value when the gas flows from the intake side to the exhaust side, and assumes a negative (−) value when the gas flows from the exhaust side to the intake side.

A curb denoted as “BASE” in FIG. 5 represents the plug part flow rate measured in a combustion chamber for comparison having no squish area nor reverse squish area. More specifically, the plug part flow rate takes positive values well before the compression top dead center, but is lowered and takes negative values as the crank angle approaches the compression top dead center. Namely, in the combustion chamber for comparison, the flow direction of the gas is reversed before the compression top dead center. A curb denoted as “WITH SQUISH” in FIG. 5 represents the plug part flow rate in the combustion chamber 18 of this embodiment. More specifically, the plug part flow rate is lowered as the crank angle approaches the compression top dead center, but still takes positive value even in the vicinity of the compression top dead center. Namely, in the combustion chamber 18 of this embodiment, reversal of gas observed in the combustion chamber for comparison is curbed or prevented.

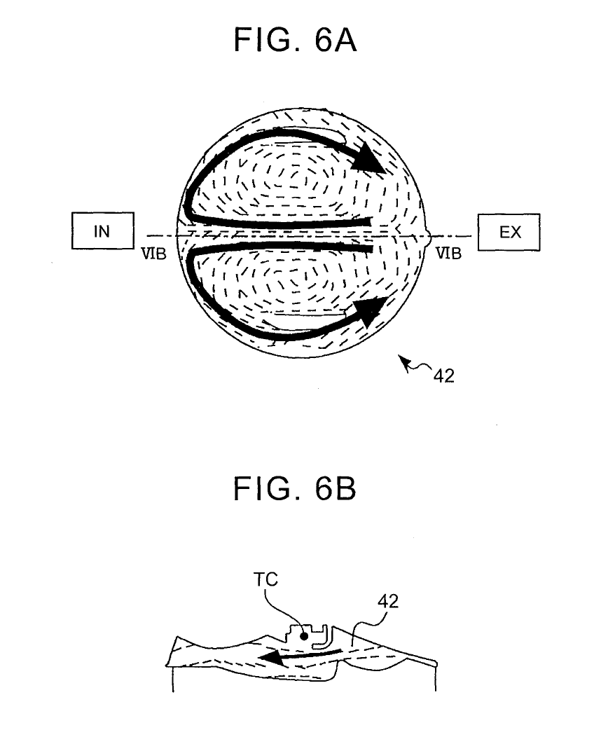

The gas flow direction is reversed in the combustion chamber for comparison because twin airflow is produced from the tumble flow. The twin airflow will be explained with reference to FIG. 6A through FIG. 8. FIG. 6A and FIG. 6B show airflow distribution at the compression top dead center in the combustion chamber for comparison. As shown in FIG. 6A, swirl flow having two axes of rotation is formed in the combustion chamber 42 for comparison. FIG. 6B shows a VIB-VIB cross-section of FIG. 6A. As shown in FIG. 6B, the center (tumble center TC) of the above-described airflow is formed in the vicinity of the ignition plug.

The airflow as described above is formed for the following reason. Namely, two streams of intake air flowing from the two intake ports in the intake stroke join together into one big tumble flow immediately after flowing into the combustion chamber 42, and the tumble flow swirls in the axial direction of the cylinder (vertical direction) in the combustion chamber 42. If the engine speed is low, the shape of the vertical swirl flow is maintained. However, as the engine speed increases, the velocity of the vertical swirl flow increases, and airflow in the intake-exhaust direction around the center of the combustion chamber 42 becomes stronger. As a result, the vertical swirl flow collapses in the compression stroke, and turns into swirl flow having two axes of rotation. Since the trace of the swirl flow into which the vertical flow turned has an ω (omega) shape, as viewed from above the combustion chamber 42, the swirl flow is called “ω tumble flow” in this specification.

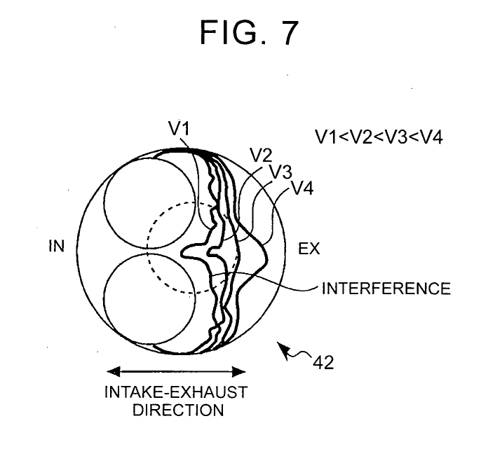

FIG. 7 shows the velocity distribution of the airflow at the compression top dead center in the combustion chamber 42. As shown in FIG. 7, in the central portion of the combustion chamber 42, the airflow velocities V are distributed at relatively wide intervals in the intake-exhaust direction. On the other hand, the airflow velocities V are distributed at narrow intervals, in a peripheral portion of the combustion chamber 42. This is because airflows concentrate in the vicinity of the central portion of the combustion chamber 42, and interfere with each other, so that airflow components are generated in a direction perpendicular to the intake-exhaust direction.

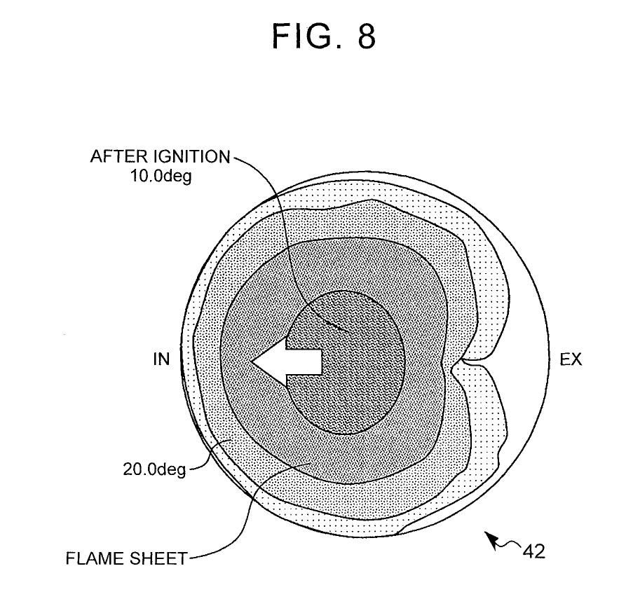

If the ω tumble flow is formed in the combustion chamber, flame propagation after ignition is deflected. FIG. 8 shows flame propagation in the combustion chamber 42 with a lapse of time. In the example of FIG. 8, the ignition timing is set to the compression top dead center. As shown in FIG. 8, a flame initiated in a central portion of the combustion chamber 42 propagates toward a side wall of the combustion chamber 42 (i.e., a wall of a cylinder bore) while expanding in magnitude. However, if the ω tumble flow is formed, airflow from the exhaust side to the intake side is produced, and therefore, the flame is not formed in the shape of an exact circle, but is distorted in shape. This may result in occurrence of knocking, or delay in combustion of fuel.

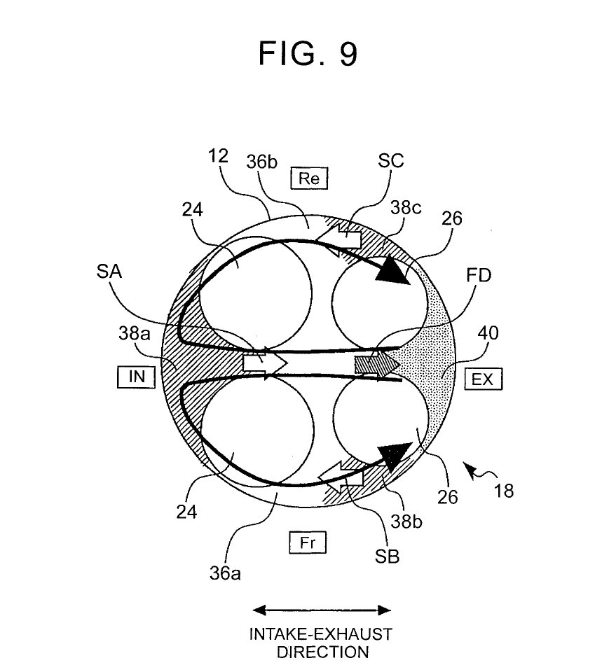

In this respect, according to the structure of the combustion chamber 18, the ω tumble flow is less likely or unlikely to be formed. FIG. 9 is a view useful for explaining the effects based on the structure of the combustion chamber 18. As shown in FIG. 9, squish flow SA and airflow FD are produced so as to cancel a component located in the central portion and flowing in the intake-exhaust direction, as a part of the airflow components that constitute the w tumble flow, and squish flows SB, SC are produced so as to cancel components located in the outer peripheral portion and flowing in the intake-exhaust direction, as parts of the airflow components that constitute the ω tumble flow. Accordingly, distortion of the flame in the combustion chamber can be corrected, and occurrence of knocking can be favorably curbed. Also, reduction of the combustion speed of the fuel can be curbed. Therefore, even in the case where EGR gas having lower ignitability than new air is introduced into the combustion chamber, a problem, such as misfiring, is less likely or unlikely to occur. Accordingly, when the internal combustion engine 10 is equipped with an EGR system, a larger quantity of EGR gas can be introduced into the engine 10.

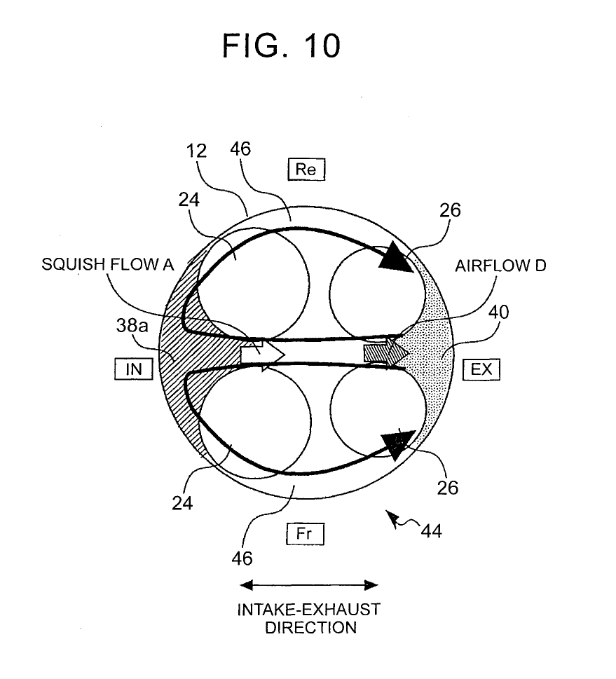

While the three regions 38a-38c are formed in the combustion chamber 18 in the above-described embodiment, the regions 38b, 38c may not be formed. FIG. 10 illustrates a modified example of this embodiment. An outer peripheral portion of a combustion chamber 44 shown in FIG. 10 consists of three types of regions 46, 38a, 40, like the combustion chamber 18. The combustion chamber 44 is different from the combustion chamber 18 only in that the combustion chamber 44 does not have the regions 38b, 38c.

With the regions 38a, 40 thus formed, squash flow SA and airflow FD can be produced in the vicinity of the compression top dead center. Accordingly, the component located in the central portion and flowing in the intake-exhaust direction, as a part of the airflow components that constitute the w tumble flow, can be cancelled out. The components located in the outer peripheral portion and flowing in the intake-exhaust direction, as parts of the airflow components that constitute the co tumble flow, are produced due to flow of the component located in the central portion along the intake-side side face of the combustion chamber 44. Therefore, if the component of the central portion can be cancelled out, the components of the outer peripheral portion are not produced. Accordingly, the formation of the w tumble flow can also be curbed, owing to the structure of the combustion chamber 44.

In the above-described embodiment, the region 38a corresponds to “first region”. Also, the region 40 corresponds to “second region”. Also, the regions 36a, 37b correspond to “third regions”, and the regions 38b, 38c correspond to “regions in which sub squish areas are located”.

What is claimed is:

1. A combustion chamber structure for an internal combustion engine, the combustion chamber structure being configured to produce tumble flow as airflow directed from an intake side to an exhaust side, in the vicinity of an upper wall of a combustion chamber, the combustion chamber structure comprising:
a squish area located in a first region surrounded by an opening of two intake ports and a wall of a cylinder bore in an outer peripheral portion of the combustion chamber, the first region of the combustion chamber having a first height as measured in an axial direction of a cylinder when a piston of the internal combustion engine is located at a top dead center, the first height being smaller than a height of any region of the outer peripheral portion of the combustion chamber other than the first region;
a reverse squish area located in a second region surrounded by an opening of an exhaust port and the wall of the cylinder bore in the outer peripheral portion of the combustion chamber, the second region of the combustion chamber having a second height as measured in the axial direction of the cylinder when the piston is located at the top dead center, the second height being larger than a height of any region of the outer peripheral portion of the combustion chamber other than the second region.

2. The combustion chamber structure according to claim 1, further comprising:
a middle area located in a third region surrounded by the opening of the two intake ports, the opening of the exhaust port, and the wall of the cylinder bore, in the outer peripheral portion of the combustion chamber, the third region having a third height as measured in the axial direction of the cylinder when the piston is located at the top dead center, the third height being between the first height of the first region and the second height of the second region; and
a sub squish area located between the middle area and the reverse squish area, the sub squish area having a height substantially equal to the first height of the first region when the piston is located at the top dead center.
